(19) United States
(12) Patent Application Publication
(10) Pub. No.: US 2024/0070287 A1
(43) Pub. Date: Feb. 29, 2024

(54) FASTER WEB APPLICATION SCANS OF WEB PAGE DATA BASED ON DEDUPLICATION

(71) Applicant: Tenable, Inc., Columbia, MD (US)

(72) Inventors: Fergus COONEY, Toronto (CA); Greg KURUC, Ellicott City, MD (US); Axel TESSIER, Bougival (FR)

(21) Appl. No.: 17/823,632

(22) Filed: Aug. 31, 2022

(51) Int. Cl. G06F 21/57; G06F 16/958

(52) U.S. Cl. CPC G06F 21/577; G06F 16/958; G06F 2221/034

(57) ABSTRACT

In an embodiment, a web application scanner (WAS) component retrieves first web page data associated with a first web page, and produces first deduplicated web page data associated with the first web page data by performing multiple deduplication functions to remove specific elements from the first web page data. The WAS component selectively scans the first web page via a security scan function based on a degree of similarity between the first deduplicated web page data and second deduplicated web page data that is deduplicated from second web page data associated with a second web page.

### TECHNICAL FIELD

The various aspects and embodiments described herein generally relate to web application scans of web page content based on deduplication.

### BACKGROUND

Web applications can be an essential way to conduct business. Unfortunately, web applications can also be vulnerable to attacks (e.g., denial of service, disclosure of private information, network infiltration, etc.) due to their exposure to public Internet. Thus, addressing vulnerabilities before an attacker can exploit them is a high priority. Web application scanning (WAS) can be performed to identify vulnerabilities associated with web applications. For example, a web application scanner (or simply “scanner”) may be used to scan externally accessible website page for vulnerable web applications.

WAS scans may take a relatively long time to perform, and many scans of redundant web pages or substantially redundant web pages may be performed. For example, a newly scanned web page may include only altered content (e.g., text, images, video, etc.) without any functional alterations, making that scan redundant.

When crawling a web application, a large number of web pages are discovered. Hence, deciding which of these web pages to audit via a security audit scan, and which will provide little to no benefit in auditing via the security audit scan, may help to reduce WAS scan times.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating a web application scanner component includes retrieving first web page data associated with a first web page; producing first deduplicated web page data associated with the first web page data by performing (i) a first deduplication function on the first web page data to remove one or more non-auditable vector elements from the first web page data, and (ii) a second deduplication function on the first web page data to remove one or more attack vector elements from the first web page data that are already queued for scanning via a security scan function or have already been scanned via the security scan function; and selectively scanning the first web page via the security scan function based on a degree of similarity between the first deduplicated web page data and second deduplicated web page data that is deduplicated from second web page data associated with a second web page.

In an aspect, a web application scanner component includes a memory; and at least one processor communicatively coupled to the memory, the at least one processor configured to: retrieve first web page data associated with a first web page; produce first deduplicated web page data associated with the first web page data by performing (i) a first deduplication function on the first web page data to remove one or more non-auditable vector elements from the first web page data, and (ii) a second deduplication function on the first web page data to remove one or more attack vector elements from the first web page data that are already queued for scanning via a security scan function or have already been scanned via the security scan function; and selectively scan the first web page via the security scan function based on a degree of similarity between the first deduplicated web page data and second deduplicated web page data that is deduplicated from second web page data associated with a second web page.

In an aspect, a non-transitory computer-readable medium storing computer-executable instructions that, when executed by a web application scanner component, cause the web application scanner component to: retrieve first web page data associated with a first web page; produce first deduplicated web page data associated with the first web page data by performing (i) a first deduplication function on the first web page data to remove one or more non-auditable vector elements from the first web page data, and (ii) a second deduplication function on the first web page data to remove one or more attack vector elements from the first web page data that are already queued for scanning via a security scan function or have already been scanned via the security scan function; and selectively scan the first web page via the security scan function based on a degree of similarity between the first deduplicated web page data and second deduplicated web page data that is deduplicated from second web page data associated with a second web page.

Other objects and advantages associated with the aspects disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary network having various assets that can be managed using a vulnerability management system, according to various aspects.

FIG. 2 illustrates another exemplary network having various assets that can be managed using a vulnerability management system, according to various aspects.

FIG. 3 illustrates a diagram of an example system suitable for interactive remediation of vulnerabilities of web applications based on scanning of web applications.

FIG. 4 illustrates a server, according to aspects of the disclosure.

FIG. 5 illustrates a web application crawling procedure, in accordance with aspects of the disclosure.

FIG. 6 illustrates an example of a web application, in accordance with aspects of the disclosure.

FIG. 7 illustrates a web scanning process, according to aspects of the disclosure.

FIG. 8 illustrates an example of a web application based on an example implementation of the web scanning process of FIG. 7, in accordance with aspects of the disclosure.

FIG. 9 illustrates an example implementation of the web scanning process of FIG. 7, in accordance with aspects of the disclosure.

FIG. 10 illustrates an example implementation of the web scanning process of FIG. 7, in accordance with aspects of the disclosure.

FIG. 11 generally illustrates a user equipment (UE) in accordance with aspects of the disclosure.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the term “asset” and variants thereof may generally refer to any suitable uniquely defined electronic object that has been identified via one or more preferably unique but possibly non-unique identifiers or identification attributes (e.g., a universally unique identifier (UUID), a Media Access Control (MAC) address, a Network BIOS (NetBIOS) name, a Fully Qualified Domain Name (FQDN), an Internet Protocol (IP) address, a tag, a CPU ID, an instance ID, a Secure Shell (SSH) key, a user-specified identifier such as a registry setting, file content, information contained in a record imported from a configuration management database (CMDB), etc.). For example, the various aspects and embodiments described herein contemplate that an asset may be a physical electronic object such as, without limitation, a desktop computer, a laptop computer, a server, a storage device, a network device, a phone, a tablet, a wearable device, an Internet of Things (IoT) device, a set-top box or media player, etc. Furthermore, the various aspects and embodiments described herein contemplate that an asset may be a virtual electronic object such as, without limitation, a cloud instance, a virtual machine instance, a container, etc., a web application that can be addressed via a Uniform Resource Identifier (URI) or Uniform Resource Locator (URL), and/or any suitable combination thereof. Those skilled in the art will appreciate that the above-mentioned examples are not intended to be limiting but instead are intended to illustrate the ever-evolving types of resources that can be present in a modem computer network. As such, the various aspects and embodiments to be described in further detail below may include various techniques to manage network vulnerabilities according to an asset-based (rather than host-based) approach, whereby the various aspects and embodiments described herein contemplate that a particular asset can have multiple unique identifiers (e.g., a UUID and a MAC address) and that a particular asset can have multiples of a given unique identifier (e.g., a device with multiple network interface cards (NICs) may have multiple unique MAC addresses). Furthermore, as will be described in further detail below, the various aspects and embodiments described herein contemplate that a particular asset can have one or more dynamic identifiers that can change over time (e.g., an IP address) and that different assets may share a non-unique identifier (e.g., an IP address can be assigned to a first asset at a first time and assigned to a second asset at a second time). Accordingly, the identifiers or identification attributes used to define a given asset may vary with respect to uniqueness and the probability of multiple occurrences, which may be taken into consideration in reconciling the particular asset to which a given data item refers. Furthermore, in the elastic licensing model described herein, an asset may be counted as a single unit of measurement for licensing purposes.

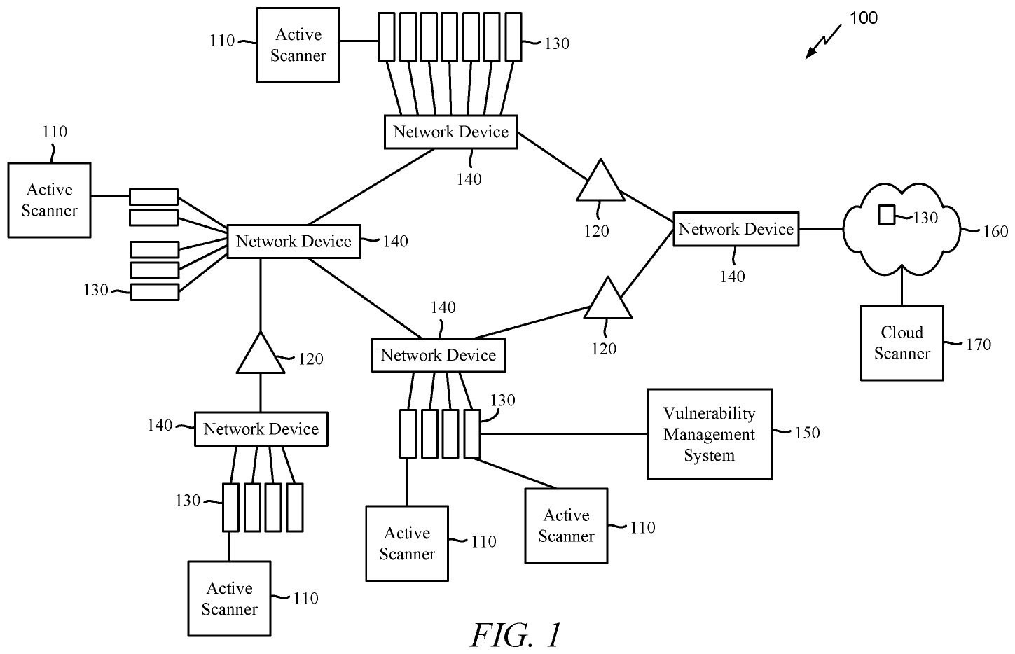

According to various aspects, FIG. 1 illustrates an exemplary network 100 having various assets 130 that are interconnected via one or more network devices 140 and managed using a vulnerability management system 150. More particularly, as noted above, the assets 130 may include various types, including traditional assets (e.g., physical desktop computers, servers, storage devices, etc.), web applications that run self-supporting code, Internet of Things (IoT) devices (e.g., consumer appliances, conference room utilities, cars parked in office lots, physical security systems, etc.), mobile or bring-your-own-device (BYOD) resources (e.g., laptop computers, mobile phones, tablets, wearables, etc.), virtual objects (e.g., containers and/or virtual machine instances that are hosted within the network 100, cloud instances hosted in off-site server environments, etc.). Those skilled in the art will appreciate that the assets 130 listed above are intended to be exemplary only and that the assets 130 associated with the network 100 may include any suitable combination of the above-listed asset types and/or other suitable asset types. Furthermore, in various embodiments, the one or more network devices 140 may include wired and/or wireless access points, small cell base stations, network routers, hubs, spanned switch ports, network taps, choke points, and so on, wherein the network devices 140 may also be included among the assets 130 despite being labelled with a different reference numeral in FIG. 1.

According to various aspects, the assets 130 that make up the network 100 (including the network devices 140 and any assets 130 such as cloud instances that are hosted in an off-site server environment or other remote network 160) may collectively form an attack surface that represents the sum total of resources through which the network 100 may be vulnerable to a cyberattack. As will be apparent to those skilled in the art, the diverse nature of the various assets 130 make the network 100 substantially dynamic and without clear boundaries, whereby the attack surface may expand and contract over time in an often unpredictable manner thanks to trends like BYOD and DevOps, thus creating security coverage gaps and leaving the network 100 vulnerable. For example, due at least in part to exposure to the interconnectedness of new types of assets 130 and abundant software changes and updates, traditional assets like physical desktop computers, servers, storage devices, and so on are more exposed to security vulnerabilities than ever before. Moreover, vulnerabilities have become more and more common in self-supported code like web applications as organizations seek new and innovative ways to improve operations. Although delivering custom applications to employees, customers, and partners can increase revenue, strengthen customer relationships, and improve efficiency, these custom applications may have flaws in the underlying code that could expose the network 100 to an attack. In other examples, IoT devices are growing in popularity and address modern needs for connectivity but can also add scale and complexity to the network 100, which may lead to security vulnerabilities as IoT devices are often designed without security in mind. Furthermore, trends like mobility, BYOD, etc. mean that more and more users and devices may have access to the network 100, whereby the idea of a static network with devices that can be tightly controlled is long gone. Further still, as organizations adopt DevOps practices to deliver applications and services faster, there is a shift in how software is built and short-lived asses like containers and virtual machine instances are used. While these types of virtual assets can help organizations increase agility, they also create significant new exposure for security teams. Even the traditional idea of a perimeter for the network 100 is outdated, as many organizations are connected to cloud instances that are hosted in off-site server environments, increasing the difficulty to accurately assess vulnerabilities, exposure, and overall risk from cyberattacks that are also becoming more sophisticated, more prevalent, and more likely to cause substantial damage.

Accordingly, to address the various security challenges that may arise due to the network 100 having an attack surface that is substantially elastic, dynamic, and without boundaries, the vulnerability management system 150 may include various components that are configured to help detect and remediate vulnerabilities in the network 100.

More particularly, the network 100 may include one or more active scanners 110 configured to communicate packets or other messages within the network 100 to detect new or changed information describing the various network devices 140 and other assets 130 in the network 100. For example, in one implementation, the active scanners 110 may perform credentialed audits or uncredentialed scans to scan certain assets 130 in the network 100 and obtain information that may then be analyzed to identify potential vulnerabilities in the network 100. More particularly, in one implementation, the credentialed audits may include the active scanners 110 using suitable authentication technologies to log into and obtain local access to the assets 130 in the network 100 and perform any suitable operation that a local user could perform thereon without necessarily requiring a local agent. Alternatively and/or additionally, the active scanners 110 may include one or more agents (e.g., lightweight programs) locally installed on a suitable asset 130 and given sufficient privileges to collect vulnerability, compliance, and system data to be reported back to the vulnerability management system 150. As such, the credentialed audits performed with the active scanners 110 may generally be used to obtain highly accurate host-based data that includes various client-side issues (e.g., missing patches, operating system settings, locally running services, etc.). On the other hand, the uncredentialed audits may generally include network-based scans that involve communicating packets or messages to the appropriate asset(s) 130 and observing responses thereto in order to identify certain vulnerabilities (e.g., that a particular asset 130 accepts spoofed packets that may expose a vulnerability that can be exploited to close established connections). Furthermore, as shown in FIG. 1, one or more cloud scanners 170 may be configured to perform a substantially similar function as the active scanners 110, except that the cloud scanners 170 may also have the ability to scan assets 130 like cloud instances that are hosted in a remote network 160 (e.g., an off-site server environment or other suitable cloud infrastructure).

Additionally, in various implementations, one or more passive scanners 120 may be deployed within the network 100 to observe or otherwise listen to traffic in the network 100, to identify further potential vulnerabilities in the network 100, and to detect activity that may be targeting or otherwise attempting to exploit previously identified vulnerabilities. In one implementation, as noted above, the active scanners 110 may obtain local access to one or more of the assets 130 in the network 100 (e.g., in a credentialed audit) and/or communicate various packets or other messages within the network 100 to illicit responses from one or more of the assets 130 (e.g., in an uncredentialed scan). In contrast, the passive scanners 120 may generally observe (or “sniff”) various packets or other messages in the traffic traversing the network 100 to passively scan the network 100. In particular, the passive scanners 120 may reconstruct one or more sessions in the network 100 from information contained in the sniffed traffic, wherein the reconstructed sessions may then be used in combination with the information obtained with the active scanners 110 to build a model or topology describing the network 100. For example, in one implementation, the model or topology built from the information obtained with the active scanners 110 and the passive scanners 120 may describe any network devices 140 and/or other assets 130 that are detected or actively running in the network 100, any services or client-side software actively running or supported on the network devices 140 and/or other assets 130, and trust relationships associated with the various network devices 140 and/or other assets 130, among other things. In one implementation, the passive scanners 120 may further apply various signatures to the information in the observed traffic to identify vulnerabilities in the network 100 and determine whether any data in the observed traffic potentially targets such vulnerabilities. In one implementation, the passive scanners 120 may observe the network traffic continuously, at periodic intervals, on a pre-configured schedule, or in response to determining that certain criteria or conditions have been satisfied. The passive scanners 120 may then automatically reconstruct the network sessions, build or update the network model, identify the network vulnerabilities, and detect the traffic potentially targeting the network vulnerabilities in response to new or changed information in the network 100.

In one implementation, as noted above, the passive scanners 120 may generally observe the traffic traveling across the network 100 to reconstruct one or more sessions occurring in the network 100, which may then be analyzed to identify potential vulnerabilities in the network 100 and/or activity targeting the identified vulnerabilities, including one or more of the reconstructed sessions that have interactive or encrypted characteristics (e.g., due to the sessions including packets that had certain sizes, frequencies, randomness, or other qualities that may indicate potential backdoors, covert channels, or other vulnerabilities in the network 100). Accordingly, the passive scanners 120 may monitor the network 100 in substantially real-time to detect any potential vulnerabilities in the network 100 in response to identifying interactive or encrypted sessions in the packet stream (e.g., interactive sessions may typically include activity occurring through keyboard inputs, while encrypted sessions may cause communications to appear random, which can obscure activity that installs backdoors or rootkit applications). Furthermore, in one implementation, the passive scanners 120 may identify changes in the network 100 from the encrypted and interactive sessions (e.g., an asset 130 corresponding to a new e-commerce server may be identified in response to the passive scanners 120 observing an encrypted and/or interactive session between a certain host located in the remote network 160 and a certain port that processes electronic transactions). In one implementation, the passive scanners 120 may observe as many sessions in the network 100 as possible to provide optimal visibility into the network 100 and the activity that occurs therein. For example, in one implementation, the passive scanners 120 may be deployed at any suitable location that enables the passive scanners 120 to observe traffic going into and/or out of one or more of the network devices 140. In one implementation, the passive scanners 120 may be deployed on any suitable asset 130 in the network 100 that runs a suitable operating system (e.g., a server, host, or other device that runs Red Hat Linux or FreeBSD open source operating system, a UNIX, Windows, or Mac OS X operating system, etc.).

Furthermore, in one implementation, the various assets and vulnerabilities in the network 100 may be managed using the vulnerability management system 150, which may provide a unified security monitoring solution to manage the vulnerabilities and the various assets 130 that make up the network 100. In particular, the vulnerability management system 150 may aggregate the information obtained from the active scanners 110 and the passive scanners 120 to build or update the model or topology associated with the network 100, which may generally include real-time information describing various vulnerabilities, applied or missing patches, intrusion events, anomalies, event logs, file integrity audits, configuration audits, or any other information that may be relevant to managing the vulnerabilities and assets in the network 100. As such, the vulnerability management system 150 may provide a unified interface to mitigate and manage governance, risk, and compliance in the network 100.

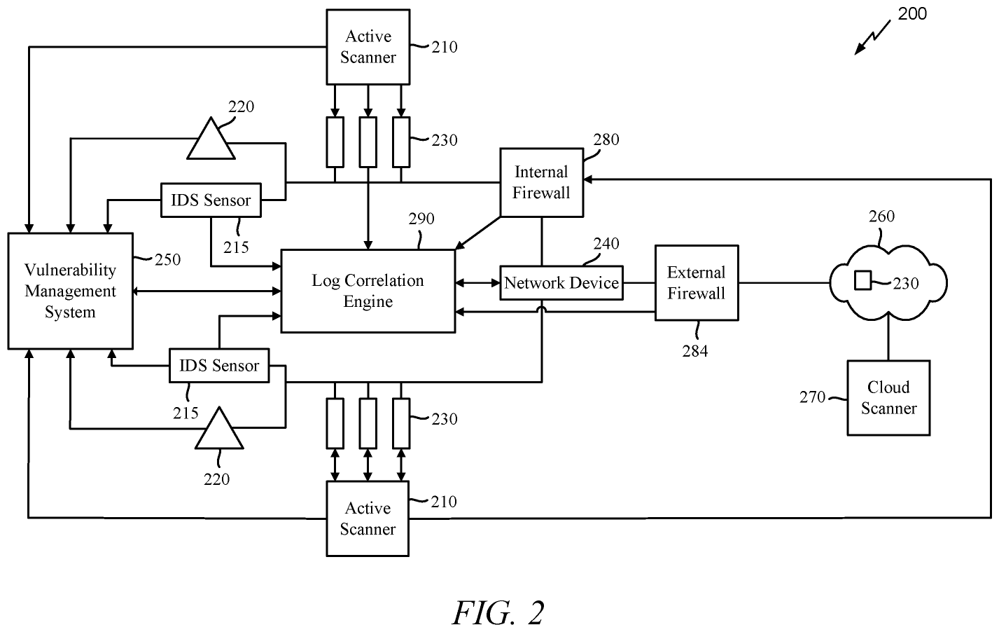

According to various aspects, FIG. 2 illustrates another exemplary network 200 with various assets 230 that can be managed using a vulnerability management system 250. In particular, the network 200 shown in FIG. 2 may have various components and perform substantially similar functionality as described above with respect to the network 100 shown in FIG. 1. For example, in one implementation, the network 200 may include one or more active scanners 210 and/or cloud scanners 270, which may interrogate assets 230 in the network 200 to build a model or topology of the network 200 and identify various vulnerabilities in the network 200, one or more passive scanners 220 that can passively observe traffic in the network 200 to further build the model or topology of the network 200, identify further vulnerabilities in the network 200, and detect activity that may potentially target or otherwise exploit the vulnerabilities. Additionally, in one implementation, a log correlation engine 290 may be arranged to receive logs containing events from various sources distributed across the network 200. For example, in one implementation, the logs received at the log correlation engine 290 may be generated by internal firewalls 280, external firewalls 284, network devices 240, assets 230, operating systems, applications, or any other suitable resource in the network 200. Accordingly, in one implementation, the information obtained from the active scanners 210, the cloud scanners 270, the passive scanners 220, and the log correlation engine 290 may be provided to the vulnerability management system 250 to generate or update a comprehensive model associated with the network 200 (e.g., topologies, vulnerabilities, assets, etc.).

In one implementation, the active scanners 210 may be strategically distributed in locations across the network 200 to reduce stress on the network 200. For example, the active scanners 210 may be distributed at different locations in the network 200 in order to scan certain portions of the network 200 in parallel, whereby an amount of time to perform the active scans may be reduced. Furthermore, in one implementation, one or more of the active scanners 210 may be distributed at a location that provides visibility into portions of a remote network 260 and/or offloads scanning functionality from the managed network 200. For example, as shown in FIG. 2, one or more cloud scanners 270 may be distributed at a location in communication with the remote network 260, wherein the term “remote network” as used herein may refer to the Internet, a partner network, a wide area network, a cloud infrastructure, and/or any other suitable external network. As such, the terms “remote network,” “external network,” “partner network,” and “Internet” may all be used interchangeably to suitably refer to one or more networks other than the networks 100, 200 that are managed using the vulnerability management systems 150, 250, while references to “the network” and/or “the internal network” may generally refer to the areas that the systems and methods described herein may be used to protect or otherwise manage. Accordingly, in one implementation, limiting the portions in the managed network 200 and/or the remote network 260 that the active scanners 210 are configured to interrogate, probe, or otherwise scan and having the active scanners 210 perform the scans in parallel may reduce the amount of time that the active scans consume because the active scanners 210 can be distributed closer to scanning targets. In particular, because the active scanners 210 may scan limited portions of the network 200 and/or offload scanning responsibility to the cloud scanners 270, and because the parallel active scans may obtain information from the different portions of the network 200, the overall amount of time that the active scans consume may substantially correspond to the amount of time associated with one active scan.

As such, in one implementation, the active scanners 210 and/or cloud scanners 270 may generally scan the respective portions of the network 200 to obtain information describing vulnerabilities and assets in the respective portions of the network 200. In particular, the active scanners 210 and/or cloud scanners 270 may perform the credentialed and/or uncredentialed scans in the network in a scheduled or distributed manner to perform patch audits, web application tests, operating system configuration audits, database configuration audits, sensitive file or content searches, or other active probes to obtain information describing the network. For example, the active scanners 210 and/or cloud scanners 270 may conduct the active probes to obtain a snapshot that describes assets actively running in the network 200 at a particular point in time (e.g., actively running network devices 240, internal firewalls 280, external firewalls 284, and/or other assets 230). In various embodiments, the snapshot may further include any exposures that the actively running assets to vulnerabilities identified in the network 200 (e.g., sensitive data that the assets contain, intrusion events, anomalies, or access control violations associated with the assets, etc.), configurations for the actively running assets (e.g., operating systems that the assets run, whether passwords for users associated with the assets comply with certain policies, whether assets that contain sensitive data such as credit card information comply with the policies and/or industry best practices, etc.), or any other information suitably describing vulnerabilities and assets actively detected in the network 200. In one implementation, in response to obtaining the snapshot of the network 200, the active scanners 210 and/or cloud scanners 270 may then report the information describing the snapshot to the vulnerability management system 250, which may use the information provided by the active scanners 210 to remediate and otherwise manage the vulnerabilities and assets in the network.

Furthermore, in one implementation, the passive scanners 220 may be distributed at various locations in the network 200 to monitor traffic traveling across the network 200, traffic originating within the network 200 and directed to the remote network 260, and traffic originating from the remote network 260 and directed to the network 200, thereby supplementing the information obtained with the active scanners 210. For example, in one implementation, the passive scanners 220 may monitor the traffic traveling across the network 200 and the traffic originating from and/or directed to the remote network 260 to identify vulnerabilities, assets, or information that the active scanners 210 may be unable to obtain because the traffic may be associated with previously inactive assets that later participate in sessions on the network. Additionally, in one implementation, the passive scanners 220 may be deployed directly within or adjacent to an intrusion detection system sensor 215, which may provide the passive scanners 220 with visibility relating to intrusion events or other security exceptions that the intrusion detection system (IDS) sensor 215 identifies. In one implementation, the IDS may be an open source network intrusion prevention and detection system (e.g., Snort), a packet analyzer, or any other system that having a suitable IDS sensor 215 that can detect and prevent intrusion or other security events in the network 200.

Accordingly, in various embodiments, the passive scanners 220 may sniff one or more packets or other messages in the traffic traveling across, originating from, or directed to the network 200 to identify new network devices 240, internal firewalls 280, external firewalls 284, or other assets 230 in addition to open ports, client/server applications, any vulnerabilities, or other activity associated therewith. In addition, the passive scanners 220 may further monitor the packets in the traffic to obtain information describing activity associated with web sessions, Domain Name System (DNS) sessions, Server Message Block (SMB) sessions, File Transfer Protocol (FTP) sessions, Network File System (NFS) sessions, file access events, file sharing events, or other suitable activity that occurs in the network 200. In one implementation, the information that the passive scanners 220 obtains from sniffing the traffic traveling across, originating from, or directed to the network 200 may therefore provide a real-time record describing the activity that occurs in the network 200. Accordingly, in one implementation, the passive scanners 220 may behave like a security motion detector on the network 200, mapping and monitoring any vulnerabilities, assets, services, applications, sensitive data, and other information that newly appear or change in the network 200. The passive scanners 220 may then report the information obtained from the traffic monitored in the network to the vulnerability management system 250, which may use the information provided by the passive scanners 220 in combination with the information provided from the active scanners 210 to remediate and otherwise manage the network 200.

In one implementation, as noted above, the network 200 shown in FIG. 2 may further include a log correlation engine 290, which may receive logs containing one or more events from various sources distributed across the network 200 (e.g., logs describing activities that occur in the network 200, such as operating system events, file modification events, USB device insertion events, etc.). In particular, the logs received at the log correlation engine 290 may include events generated by one or more of the internal firewalls 280, external firewalls 284, network devices 240, and/or other assets 230 in the network 200 in addition to events generated by one or more operating systems, applications, and/or other suitable sources in the network 200. In one implementation, the log correlation engine 290 may normalize the events contained in the various logs received from the sources distributed across the network 200, and in one implementation, may further aggregate the normalized events with information describing the snapshot of the network 200 obtained by the active scanners 210 and/or the network traffic observed by the passive scanners 220. Accordingly, in one implementation, the log correlation engine 290 may analyze and correlate the events contained in the logs, the information describing the observed network traffic, and/or the information describing the snapshot of the network 200 to automatically detect statistical anomalies, correlate intrusion events or other events with the vulnerabilities and assets in the network 200, search the correlated event data for information meeting certain criteria, or otherwise manage vulnerabilities and assets in the network 200.

Furthermore, in one implementation, the log correlation engine 290 may filter the events contained in the logs, the information describing the observed network traffic, and/or the information describing the snapshot of the network 200 to limit the information that the log correlation engine 290 normalizes, analyzes, and correlates to information relevant to a certain security posture (e.g., rather than processing thousands or millions of events generated across the network 200, which could take a substantial amount of time, the log correlation engine 290 may identify subsets of the events that relate to particular intrusion events, attacker network addresses, assets having vulnerabilities that the intrusion events and/or the attacker network addresses target, etc.). Alternatively (or additionally), the log correlation engine 290 may persistently save the events contained in all of the logs to comply with regulatory requirements providing that all logs must be stored for a certain period of time (e.g., saving the events in all of the logs to comply with the regulatory requirements while only normalizing, analyzing, and correlating the events in a subset of the logs that relate to a certain security posture). As such, the log correlation engine 290 may aggregate, normalize, analyze, and correlate information received in various event logs, snapshots obtained by the active scanners 210 and/or cloud scanners 270, and/or the activity observed by the passive scanners 220 to comprehensively monitor, remediate, and otherwise manage the vulnerabilities and assets in the network 200. Additionally, in one implementation, the log correlation engine 290 may be configured to report information relating to the information received and analyzed therein to the vulnerability management system 250, which may use the information provided by the log correlation engine 290 in combination with the information provided by the passive scanners 220, the active scanners 210, and the cloud scanners 270 to remediate or manage the network 200.

Accordingly, in various embodiments, the active scanners 210 and/or cloud scanners 270 may interrogate any suitable asset 230 in the network 200 to obtain information describing a snapshot of the network 200 at any particular point in time, the passive scanners 220 may continuously or periodically observe traffic traveling in the network 200 to identify vulnerabilities, assets, or other information that further describes the network 200, and the log correlation engine 290 may collect additional information to further identify the vulnerabilities, assets, or other information describing the network 200. The vulnerability management system 250 may therefore provide a unified solution that aggregates vulnerability and asset information obtained by the active scanners 210, the cloud scanners 270, the passive scanners 220, and the log correlation engine 290 to comprehensively manage the network 200.

Security auditing applications typically display security issues (such as vulnerabilities, security misconfigurations, weaknesses, etc.) paired with a particular solution for that given issue. Certain security issues may share a given solution, or have solutions which are superseded or otherwise rendered unnecessary by other reported solutions. Embodiments of the disclosure relate to improving an efficiency by which security issues are reported, managed and/or rectified based on solution supersedence.

In accordance with a first embodiment, when working with security reporting datasets with sparse metadata available, the reported solutions for each security issue are combined, and various “rulesets” are applied against the combined solutions to de-duplicate them and remove solutions that have been superseded by other solutions. As used herein, a ruleset is a set of rules that govern when a solution is to be removed or merged with another and how that merge is to be accomplished. In an example, when solution texts not matching a given ruleset are discovered they are flagged for manual review. Examples of rules that may be included in one or more rulesets are as follows:
If there is more than one matching solution in the solution list, remove all but one of those solutions.
For solutions matching “Upgrade to <product> x.y.z” where x, y, and z are integers, select a single result with the highest x.y.z value (comparing against x first, then y, then z).
For solutions matching “Apply fix <fix> to <product>”, create a new combined solution where <fix> for each solution is concatenated into a comma separated list for a given <product>.

In accordance with a second embodiment, when working with datasets with metadata available that have an identifier that allows grouping of solutions based on product (e.g., common product enumeration (CPE)) and timestamp information on when a fix has become available, the solutions for each group can be filtered with only display the latest “top level” solution for each group being displayed. In an example, the first and second embodiments can be implemented in conjunction with each other to produce a further refined solution set.

As used herein, a “plug-in” contains logic and metadata for an individual security check in a security auditing application. A plugin may check for one or more mitigations/fixes and flag one or more individual security issues. CPE is a standardized protocol of describing and identifying classes of applications, operating systems, and hardware devices present among an enterprise's computing assets. CPE identifiers contain asset type information (OS/Hardware/Application), vendor, product, and can even contain version information. An example CPE string is “cpe:/o:microsoft:windows_vista:6.0:sp1”, where “/o” stands for operating system, Microsoft is the vendor, windows_vista is the product, major version is 6.0, and minor version is SP1. Further, a common vulnerabilities and exposures (CVE) identifier is an identifier from a national database maintained by NIST/Mitre which keeps a list of known vulnerabilities and exposures. An example identifier would be “CVE-2014-6271” which corresponds to the “ShellShock” vulnerability in the database.

In accordance with one implementation of the second embodiment, solutions (or solution ‘texts’) may first together based on the CPEs in the plugins they were reported in. The solutions are then sorted by the patch publication date from the plugins which they were sourced from. Solutions containing text that matches a pattern that indicates that the solution is likely a patch recommendation can all be removed from the group except the solution associated with the most recent patch. In this manner, patches with identifiers that cannot be easily sorted (e.g., patches with non-numerical identifiers) and/or for which no ruleset pertains in accordance with the first embodiment can be filtered out from the solution set. In some implementations, additional ruleset-based filtering from the first embodiment can also be applied, to filter out (or de-duplicate) additional duplicate solution information.

In accordance with a third embodiment, a security auditing application may evaluate further metadata in the solution report results that is added based upon asset-specific information (e.g., such as individual patches installed, which mitigations and patches are missing, what individual software installations are installed, patch supersedence information, the relationship between the mitigations/patches and security issues, etc.).

Web applications can be an essential way to conduct business. Unfortunately, web applications can also be vulnerable to attacks (e.g., denial of service, disclosure of private information, network infiltration, etc.) due to their exposure to public internet. Thus, addressing vulnerabilities before an attacker can exploit them is a high priority. Web application scanning (WAS) can be performed to identify vulnerabilities associated with web applications. For example, a web application scanner (or simply “scanner”) may be used to scan externally accessible website page for vulnerable web applications.

WAS scans may take a relatively long time to perform, and many scans of redundant web pages or substantially redundant web pages may be performed. For example, a newly scanned web page may include only altered content (e.g., text, images, video, etc.) without any functional alterations, making that scan redundant.

When crawling a web application, a large number of web pages are discovered. Hence, deciding which of these web pages to audit via a security audit scan, and which will provide little to no benefit in auditing via the security audit scan, may help to reduce WAS scan times.

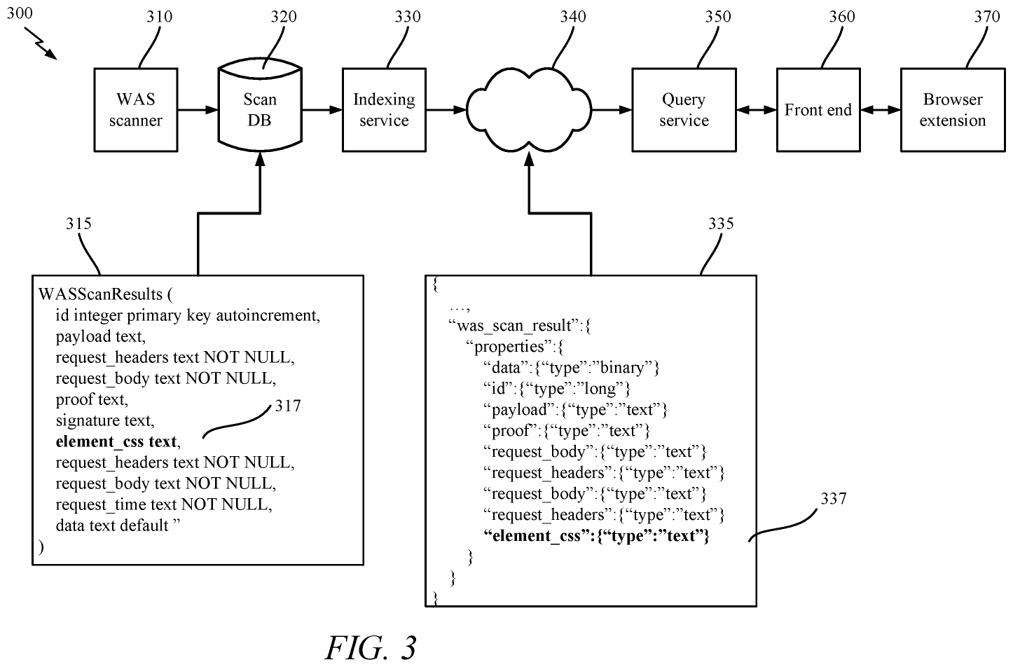

According to various aspects, FIG. 3 illustrates a diagram of an example system 300 suitable for interactive remediation of vulnerabilities of web applications based on scanning of web applications. In particular, as shown in FIG. 3, the system 300 may include a WAS scanner (or simply “scanner”) 310, a scan results 320 (e.g., a database (DB)), a first cloud service 330, a search engine 340, a second cloud service 350, a front end 360, and a browser extension 370. The first and second cloud services 330, 350 may be a same cloud service or different cloud services.

Generally, the scanner 310 may include an element selector for the vulnerable element as a part of its result placed into the scan results 320. Examples (not necessarily exhaustive) of an element selector may include CSS selector, XPath selector, Node number selector, Name selector, Id selector, LinkText selector, and so on. This information may then be passed into the search engine 340 by the first cloud service 330 and included in results from the second cloud service 350 when queried for data about specific vulnerabilities, e.g., from the front end 360. If an element selector exists, the front end 360 (e.g., browser may include a button that links back to the vulnerable URL and element.

The scanner 310 may be configured to scan web pages to identify one or more vulnerabilities of web applications, i.e., vulnerabilities of elements in web pages. In particular, the scanner 310 may include a selector (not shown) for the vulnerable element in the scan results 320. For example, the selector may implement a scanner function (selector create function) that will take the current element and produce an element selector from it. The URL the element appears on may be included as separate data. A final test may be run before including the data to ensure that the element can be gotten to or otherwise accessible without any extra browser steps that the system is unaware of. Such data may be kept in a table in the scan results 320. For example, a FIG. 3 illustrates a VulnerabilitiesDetected table 315, which includes a field for an element selector 317 denoted as “element_css”, which is of text type.

The first cloud service 330 may be configured to index the search results within scan results 320. In particular, the first cloud service 330 may be configured to ensure that the field for the element selector 317 is included when the search engine 340 performs a search. In FIG. 3, it is seen the “was_scan_results” 335 data includes the element selector data 337, which is denoted as “element_css”:{“type”:“text” }.

The second cloud service 350 may be configured to query the search engine 340 for results of WAS scanning, e.g., performed by the scanner 310. In particular, the second cloud service 350 may be configured to query the search engine 340 for the element selector data 337. For example, the second cloud service 350 may submit the following query to pick up the element selector data 337 and return its response, e.g., to the front end 360.
GET/scans/{scanId}/hosts/{hostId}/plugins/{pluginId}

The front end 360 may be configured to receive the WAS scanning results data, including the element selector data for the vulnerable elements. The front end 360 may also be configured to include a button or some other visible element, which when activated (e.g., pressed by a user) will pass message to the browser extension 370 (e.g., chrome extension). The front end 360 may pass at least the following data in the message to the browser extension 370:
URL
Element selector
Plugin ID

The browser extension 370 may be configured to take the message passed from the front end 360, open the URL, and highlight and snap to the vulnerable element. In an aspect, the browser extension 370 may open the URL in a new tab of the browser.

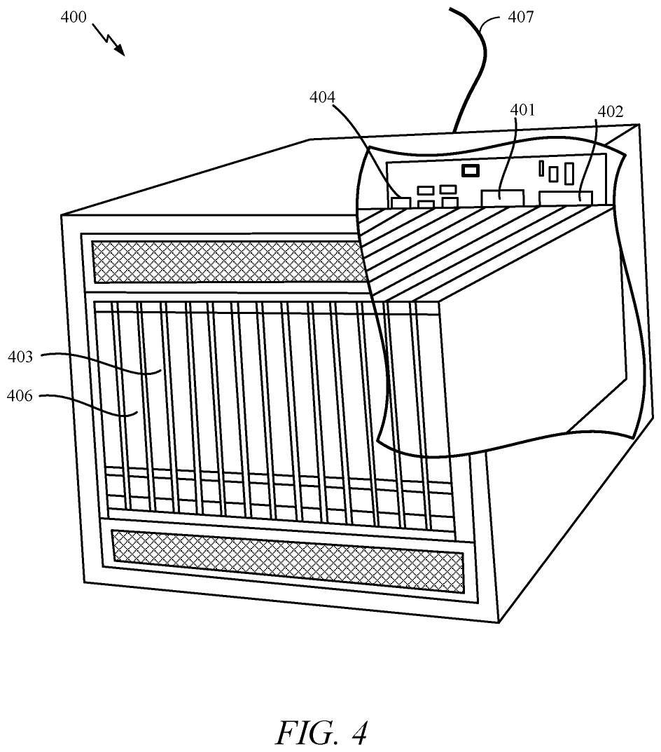

The various embodiments may be implemented on any of a variety of commercially available server devices, such as server 400 illustrated in FIG. 4. In an example, the server 400 may correspond to one example configuration of a server on which a security auditing application may execute, which in certain implementations may be included as part of the vulnerability management system 150 of FIG. 1 or the vulnerability management system 250 of FIG. 2 or WAS scanner 300 of FIG. 3. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet.

Web applications can be an essential way to conduct business. Unfortunately, web applications can also be vulnerable to attacks (e.g., denial of service, disclosure of private information, network infiltration, etc.) due to their exposure to public Internet. Thus, addressing vulnerabilities before an attacker can exploit them is a high priority. Web application scanning (WAS) can be performed to identify vulnerabilities associated with web applications. For example, a web application scanner (or simply “scanner”) may be used to scan externally accessible website page for vulnerable web applications.

WAS scans may take a relatively long time to perform, and many scans of redundant web pages or substantially redundant web pages may be performed. For example, a newly scanned web page may include only altered content (e.g., text, images, video, etc.) without any functional alterations, making that scan redundant.

When crawling a web application, a large number of web pages are discovered. Hence, deciding which of these web pages to audit via a security audit scan, and which will provide little to no benefit in auditing via the security audit scan, may help to reduce WAS scan times.

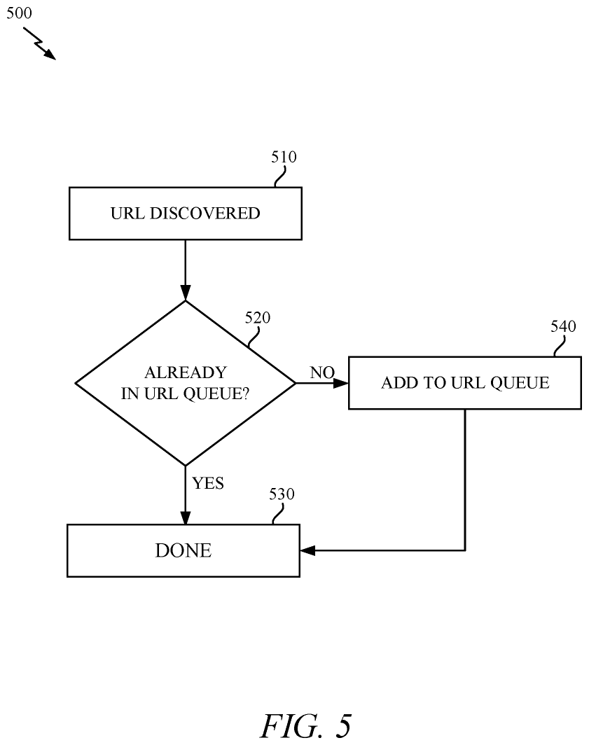

FIG. 5 illustrates a web application crawling procedure 500, in accordance with aspects of the disclosure. The web application crawling procedure 500 of FIG. 5 may be performed by a network component, such as the server 400. In some designs, the network component is a WAS component, such as the WAS scanner 310, etc. In other designs, the web application crawling procedure 500 may be performed by a dedicated web crawler (e.g., the dedicated web crawler maps out the architecture of the web application in URL queue that is then accessed/evaluated by the WAS component).

In FIG. 5, at 510, a new URL is discovered. At 520, the network component determines whether the new URL is already in a URL queue. If the new URL is already in the URL queue, then no additional action need be taken by the network component, and the process is completed at 530. If the new URL is not already in the URL queue, then the new URL is added to the URL queue at 540, after which the process is completed at 530. The web application crawling procedure 500 may repeat a number of times as new URLs in a web application are discovered during a web crawl.

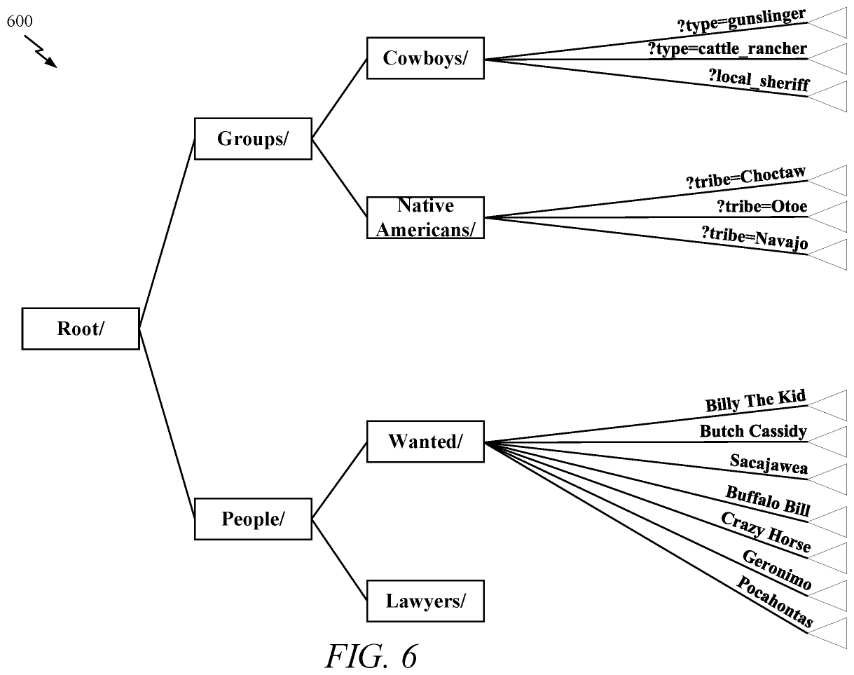

FIG. 6 illustrates an example of a web application 600, in accordance with aspects of the disclosure. In some designs, the web application 600 may comprise URLs that are discovered and populated in a URL queue as described above with respect to FIG. 5. In FIG. 5, the web application 600 exhibits a tree architecture with a root node (“Root/” at node level 0) and a number of child nodes (e.g., “Groups/” and “People/” at node level 1, “Cowboys/”, “Native Americans/”, “Wanted/”, “Lawyers/” at node level 2, and a number of child nodes at node level 3). Each node depicted at FIG. 6 represents a web page, and each node may operate as a parent node, a child node, or both, in the tree architecture of the web application 600.

One option for web scanning of the web application 600 is to simply scan all web pages (or all nodes) via a brute force technique. As noted above, such a brute force technique may result in long WAS scan times and may be resource intensive.

Another option for web scanning of the web application 600 is to perform page deduplication of certain web page data known (or assumed) to be irrelevant from the standpoint of a security scan function (referred to herein as “non-auditable vector elements”). In some designs, any data type that is not targeted for scanning by the security scan function may be characterized as a non-auditable vector element. For example, a WAS component may keep a log of pages seen using a digest function. The digest function uses a cryptographic hash function to generate a hash of the page. Prior to hashing, the WAS component may remove irrelevant web page data such as web page transition content (e.g., transitions do not always lead to a new page, any variance in a transition will cause a page hash to be entirely different, and a transition itself is not enough to make a page interesting enough to analyze), text content (e.g., text content is essentially irrelevant from a security perspective, and text content may include autogenerated classes and IDs created by JavaScript frameworks), and other irrelevant content (e.g., style/formatting content and/or other attributes).

The digest function may then operate on the remaining content, meaning similar pages will result in a collision, causing subsequent matching pages to not be audited. This deduplication technique may help reduce the number of pages audited on some web applications. However, similar pages with different URLs may still be audited. For example, if a first web page includes a search bar (i.e., an attack vector element) and a second web page does not, both web pages may be audited.

Aspects of the disclosure are thereby directed to deduplication of web pages so as to selectively skip WAS scans of web pages that are similar to or identical to deduplications of other web pages that have already been scanned or are already queued to be scanned. In particular, deduplication may be performed with respect to both non-auditable vector elements as well as attack vector elements, which may help to further reduce the scope of a WAS scan. Such aspects may allow redundant or substantially redundant WAS scans of certain web pages to be reduced or eliminated, which in turn may decrease WAS scan times and resource overhead.

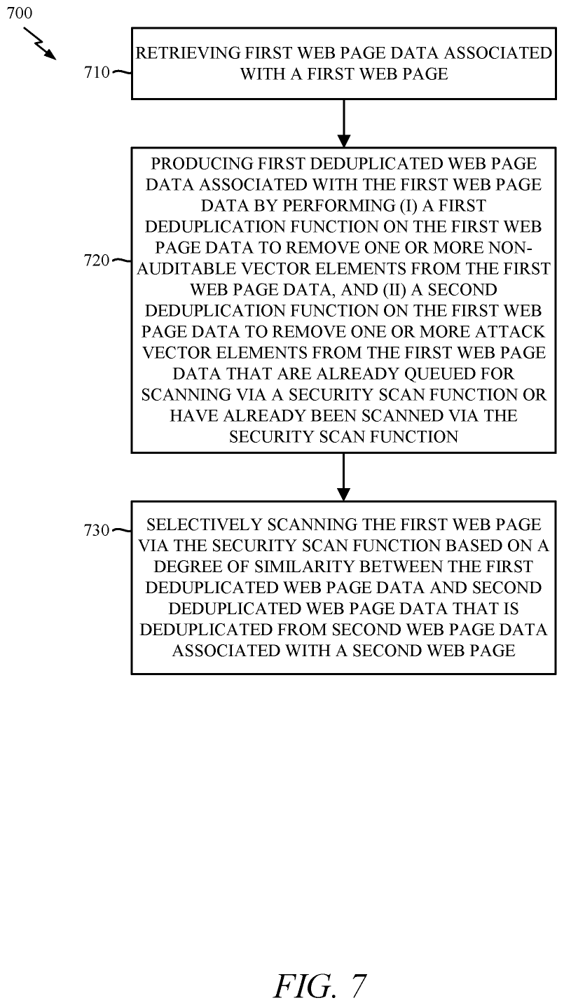

FIG. 7 illustrates a web scanning process 700, according to aspects of the disclosure. The web scanning process 700 may be performed by a WAS component, such as WAS scanner 310 of FIG. 3 or server 400 of FIG. 4. In other designs, the WAS component may be implemented as a user device or user equipment (UE) such as a laptop or desktop computer, a smart phone or tablet, etc.

At 710, the WAS component retrieves first web page data associated with a first web page. For example, a URL of the first web page may be retrieved from a URL queue, and the retrieved URL may then be accessed to retrieve the first web page data. The first web page data may include various web page data types, such as content (e.g., text, images, video, audio, etc.), style/formatting elements, forms, cookies, etc. In some designs, the first web page may be a HyperText Markup Language (HTML) web page, and the first web page data may HTML data.

At 720, the WAS component produces first deduplicated web page data associated with the first web page data by performing (i) a first deduplication function on the first web page data to remove one or more non-auditable vector elements from the first web page data, and (ii) a second deduplication function on the first web page data to remove one or more attack vector elements from the first web page data that are already queued for scanning via a security scan function or have already been scanned via the security scan function.

At a high-level, an “attack vector element” is any element that may potentially include an exploitable vulnerability and is subject to one or more scans via the security scan function. Some examples of attack vector elements include forms or cookies. A non-auditable vector element is any element that is not an attack vector element. Examples of non-auditable vector elements include web page transition content, or text content, or image content, or video content, or audio content, or any combination thereof.

At 730, the WAS component selectively scans the first web page via the security scan function based on a degree of similarity between the first deduplicated web page data and second deduplicated web page data that is deduplicated from second web page data associated with a second web page. In some designs, the second web page data is queued for scanning via the security scan function or has already been scanned via the security scan function (e.g., so the selective scanning may opt to skip at least part of the scanning of the first web page if the first web page is highly similar to another web page that has already been scanned or is already queued for scanning).

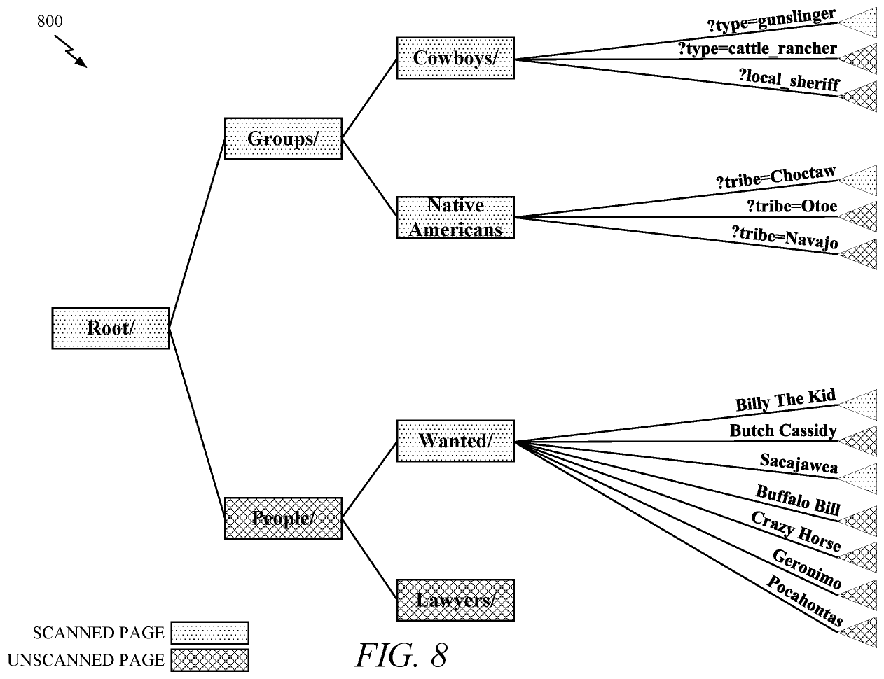

FIG. 8 illustrates an example of a web application 800 based on an example implementation of the web scanning process 700 of FIG. 7, in accordance with aspects of the disclosure. The web application 800 generally corresponds to the web application 600 of FIG. 6, except the individual nodes (web pages) of the web application 800 are labeled as either scanned or unscanned.

Referring to FIG. 8, in an example, assume that Groups/ and People/ correspond to the same web page except for differences with respect to non-auditable vector elements (e.g., text content, image content, etc.) removed via the first deduplication function and/or attack vector elements (e.g., forms, cookies, etc.) removed via the second deduplication function. In this case, further assume that Groups/ is queued in the URL queue before People/, such that Groups/ is scanned at 730 of FIG. 7 while People/ is skipped from web page scanning at 730 of FIG. 7 based on the first and/or second deduplication functions of 720 of FIG. 7 which increases the similarity between Groups/ and People/.

Referring to FIG. 8, in an example, assume that Cowboys/ and Native Americans/ are similar web pages, but Native Americans/ includes an additional form element related to tribal laws. Further assume that the form element related to tribal laws is an attack vector element that is not already queued for scanning via the security scan function or and has not already been scanned via the security scan function (i.e., is not removed via the second deduplication function at 720 of FIG. 7). In this case, both Cowboys/ and Native Americans/ are scanned at 730 of FIG. 7.

Referring to FIG. 8, in an example, assume that Wanted/ and Lawyers/ correspond to the same web page except for differences with respect to non-auditable vector elements (e.g., text content, image content, etc.) removed via the first deduplication function and/or attack vector elements (e.g., forms, cookies, etc.) removed via the second deduplication function. In this case, further assume that Wanted/ is queued in the URL queue before Lawyers/, such that Wanted/ is scanned at 730 of FIG. 7 while Lawyers/ is skipped from web page scanning at 730 of FIG. 7 based on the first and/or second deduplication functions of 720 of FIG. 7 which increases the similarity between Wanted/ and Lawyers/.

Referring to FIG. 8, in a further example, assume that the nodes (web pages) at node level 3 are added to the URL queue in order of top-to-bottom via node group (e.g., gunslinger is added first, then rancher, then local_sheriff, Choctaw is added first, then Otoe, then Navajo, etc.). Similar to the above-description, the first-discovered nodes at each node group (i.e., gunslinger, Choctaw, and Billy the Kid) are added to the URL queue. Then, the nodes denoted as cattle_rancher, local_sheriff, Otoe, Navajo, Butch Cassidy, Buffalo Bill, Crazy Horse, Geronimo and Pocahontas are all skipped based on the first and/or second deduplication functions with respect to the first-discovered node in their respective node group. However, assume that the node denoted as Sacajawea includes an attack vector element that is not already queued for scanning via the security scan function or and has not already been scanned via the security scan function (i.e., is not removed via the second deduplication function at 720 of FIG. 7). Hence, Sacajawea is scanned for this reason at 730 of FIG. 7. As will be appreciated, a number of WAS scans of web pages in the web application 800 may be skipped by virtue of the execution of the web scanning process 700 of FIG. 7.

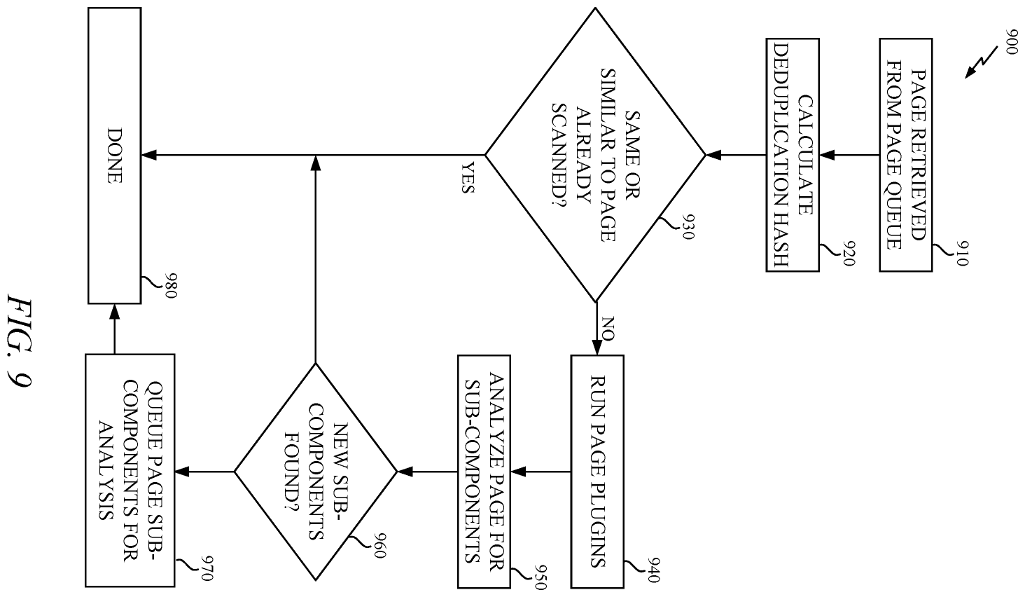

FIG. 9 illustrates an example implementation 900 of the web scanning process 700 of FIG. 7, in accordance with aspects of the disclosure. At 910, the WAS component retrieves a web page from a page queue. At 920, the WAS component calculates a deduplication hash. At 930, the WAS component determines whether the deduplication hash is the same or similar to a page (or more specifically, the deduplication hash of the page) that has already been scanned (or is already queued for scanning). If so, the process 900 ends at 980. Otherwise, web page plugins are executed at 940. At 950, the page is analyzed for sub-components. If no new sub-components are found at 950, the process ends at 980. Otherwise, the page sub-components are queued for analysis at 970, after which the process ends at 980.

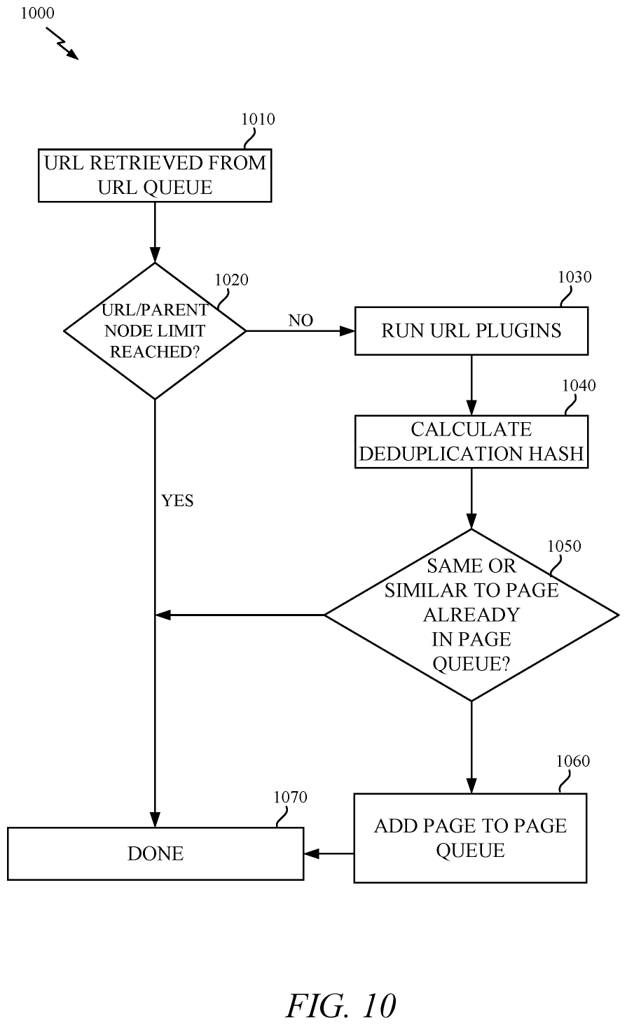

FIG. 10 illustrates an example implementation 1000 of the web scanning process 700 of FIG. 7, in accordance with aspects of the disclosure. At 1010, the WAS component retrieves a URL from the URL queue. At 1020, the WAS component determines whether a URL or parent node limit has been reached. If so, the process 1000 ends at 1070. Otherwise, the WAS component executes URL plugins at 1030, and calculates a deduplication hash at 1040. At 1050, the WAS component determines whether the deduplication hash is the same or similar to a page (or more specifically, the deduplication hash of the page) that has already been scanned (or is already queued for scanning). If so, the process 1000 ends at 1070. Otherwise, the web page is added to the page queue at 1060, after which the process ends at 1070.

Referring to FIG. 7, in an example, the deduplicated web page data comprises a hash of a portion of the first web page data that excludes the one or more non-auditable vector elements and the one or more attack vector elements.

Referring to FIG. 7, in an example, the selectively scanning at 730 of FIG. 7 scans the first web page via one or more web page plugins if the degree of similarity between the first deduplicated web page data and the second deduplicated web page data exceeds a similarity threshold. In some designs, the similarity threshold is exceeded if the first deduplicated web page data includes at least one attack vector element that is not part of the second deduplicated web page data.

Referring to FIG. 7, in some designs, if the degree of similarity between the first deduplicated web page data and the second deduplicated web page data does not exceed the similarity threshold, this may reduce but not eliminate the scanning performed on the first web page. Rather, in this case as an example, the selectively scanning at 730 of FIG. 7 may comprise scanning a server associated with the first web page via one or more server plugins of the security scan function, scanning a URL associated with the first web page via one or more URL plugins of the security scan function, and skipping a scanning of the first web page via the one or more web page plugins of the security scan function. So, the server plugins and URL plugins may be allowed to execute even on a page deemed similar/identical to another scanned (or scan-queued) page. In this case, the savings in terms of WAS scan time and resource overhead is obtained via the omission of the web page plugin-based scanning.

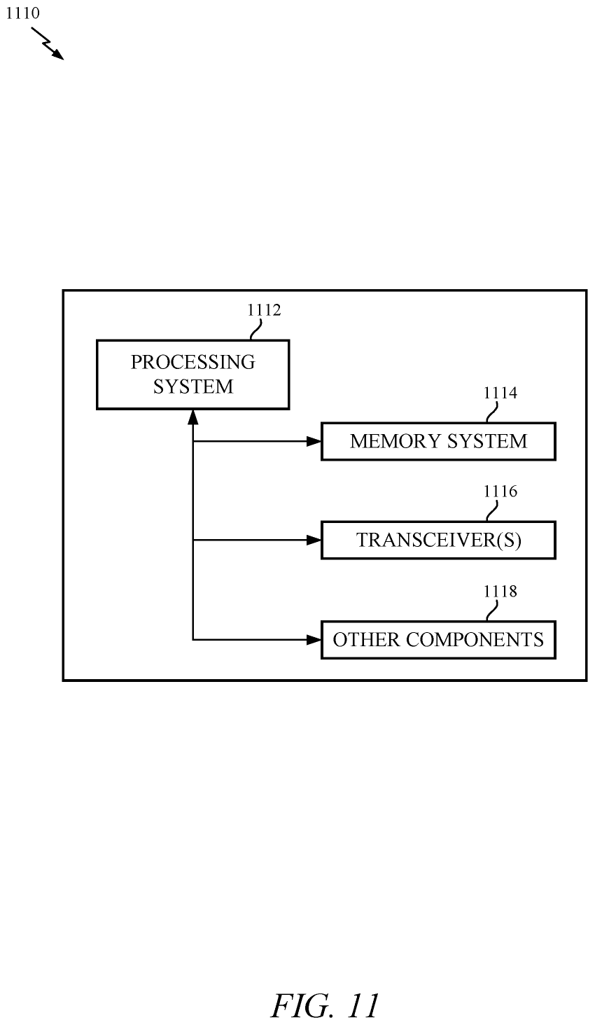

While FIG. 4 illustrates an example whereby a server-type apparatus 400 may implement various processes of the disclosure, such as the process of FIGS. 7 and 9-10, in other aspects the processes of FIGS. 7 and 9-10 in particular may execute on a user equipment (UE), such as UE 1110 depicted in FIG. 11.

FIG. 11 generally illustrates a UE 1110 in accordance with aspects of the disclosure. In some designs, UE 1110 may correspond to any UE-type that is capable of executing a WAS scanning application for performing any of the processes of FIGS. 7 and 9-10 as described above, including but not limited to a mobile phone or tablet computer, a laptop computer, a desktop computer, a wearable device (e.g., smart watch, etc.), and so on. The UE 1110 depicted in FIG. 11 includes a processing system 1112, a memory system 1114, and at least one transceiver 1116. The UE 1110 may optionally include other components 1118 (e.g., a graphics card, various communication ports, etc.).

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of operating a web application scanner component, comprising: retrieving first web page data associated with a first web page; producing first deduplicated web page data associated with the first web page data by performing (i) a first deduplication function on the first web page data to remove one or more non-auditable vector elements from the first web page data, and (ii) a second deduplication function on the first web page data to remove one or more attack vector elements from the first web page data that are already queued for scanning via a security scan function or have already been scanned via the security scan function; and selectively scanning the first web page via the security scan function based on a degree of similarity between the first deduplicated web page data and second deduplicated web page data that is deduplicated from second web page data associated with a second web page.

Clause 2. The method of clause 1, wherein the second web page data is queued for scanning via the security scan function or has already been scanned via the security scan function.

Clause 3. The method of any of clauses 1 to 2, wherein the first deduplicated web page data comprises a hash of a portion of the first web page data that excludes the one or more non-auditable vector elements and the one or more attack vector elements.

Clause 4. The method of any of clauses 1 to 3, wherein the one or more non-auditable vector elements that are removed from the first web page data via the first deduplication function include: web page transition content, or text content, or image content, or video content, or audio content, or style or formatting content, or any combination thereof.

Clause 5. The method of any of clauses 1 to 4, wherein the one or more attack vector elements comprise: one or more forms, or one or more cookies, or any combination thereof.

Clause 6. The method of any of clauses 1 to 5, wherein the selectively scanning scans the first web page via one or more web page plugins if the degree of similarity between the first deduplicated web page data and the second deduplicated web page data exceeds a similarity threshold.

Clause 7. The method of clause 6, wherein the similarity threshold is exceeded if the first deduplicated web page data includes at least one attack vector element that is not part of the second deduplicated web page data.

Clause 8. The method of any of clauses 6 to 7, wherein, if the degree of similarity between the first deduplicated web page data and the second deduplicated web page data does not exceed the similarity threshold, the selectively scanning comprises: scanning a server associated with the first web page via one or more server plugins of the security scan function, scanning a uniform resource locator (URL) associated with the first web page via one or more URL plugins of the security scan function, and skipping a scanning of the first web page via the one or more web page plugins of the security scan function.

Clause 9. A web application scanner component, comprising: a memory; and at least one processor communicatively coupled to the memory, the at least one processor configured to: retrieve first web page data associated with a first web page; produce first deduplicated web page data associated with the first web page data by performing (i) a first deduplication function on the first web page data to remove one or more non-auditable vector elements from the first web page data, and (ii) a second deduplication function on the first web page data to remove one or more attack vector elements from the first web page data that are already queued for scanning via a security scan function or have already been scanned via the security scan function; and selectively scan the first web page via the security scan function based on a degree of similarity between the first deduplicated web page data and second deduplicated web page data that is deduplicated from second web page data associated with a second web page.

Clause 10. The web application scanner component of clause 9, wherein the second web page data is queued for scanning via the security scan function or has already been scanned via the security scan function.

Clause 11. The web application scanner component of any of clauses 9 to 10, wherein the first deduplicated web page data comprises a hash of a portion of the first web page data that excludes the one or more non-auditable vector elements and the one or more attack vector elements.

Clause 12. The web application scanner component of any of clauses 9 to 11, wherein the one or more non-auditable vector elements that are removed from the first web page data via the first deduplication function include: web page transition content, or text content, or image content, or video content, or audio content, or style or formatting content, or any combination thereof.

Clause 13. The web application scanner component of any of clauses 9 to 12, wherein the one or more attack vector elements comprise: one or more forms, or one or more cookies, or any combination thereof.

Clause 14. The web application scanner component of any of clauses 9 to 13, wherein the selectively scanning scans the first web page via one or more web page plugins if the degree of similarity between the first deduplicated web page data and the second deduplicated web page data exceeds a similarity threshold.

Clause 15. The web application scanner component of clause 14, wherein the similarity threshold is exceeded if the first deduplicated web page data includes at least one attack vector element that is not part of the second deduplicated web page data.

Clause 16. The web application scanner component of any of clauses 14 to 15, wherein, if the degree of similarity between the first deduplicated web page data and the second deduplicated web page data does not exceed the similarity threshold, the selectively scanning comprises: scan a server associated with the first web page via one or more server plugins of the security scan function, scan a uniform resource locator (URL) associated with the first web page via one or more URL plugins of the security scan function, and skip a scanning of the first web page via the one or more web page plugins of the security scan function.

Clause 17. A non-transitory computer-readable medium storing computer-executable instructions that, when executed by a web application scanner component, cause the web application scanner component to: retrieve first web page data associated with a first web page; produce first deduplicated web page data associated with the first web page data by performing (i) a first deduplication function on the first web page data to remove one or more non-auditable vector elements from the first web page data, and (ii) a second deduplication function on the first web page data to remove one or more attack vector elements from the first web page data that are already queued for scanning via a security scan function or have already been scanned via the security scan function; and selectively scan the first web page via the security scan function based on a degree of similarity between the first deduplicated web page data and second deduplicated web page data that is deduplicated from second web page data associated with a second web page.

Clause 18. The non-transitory computer-readable medium of clause 17, wherein the second web page data is queued for scanning via the security scan function or has already been scanned via the security scan function.

Clause 19. The non-transitory computer-readable medium of any of clauses 17 to 18, wherein the first deduplicated web page data comprises a hash of a portion of the first web page data that excludes the one or more non-auditable vector elements and the one or more attack vector elements.

Clause 20. The non-transitory computer-readable medium of any of clauses 17 to 19, wherein the one or more non-auditable vector elements that are removed from the first web page data via the first deduplication function include: web page transition content, or text content, or image content, or video content, or audio content, or style or formatting content, or any combination thereof.

Clause 21. The non-transitory computer-readable medium of any of clauses 17 to 20, wherein the one or more attack vector elements comprise: one or more forms, or one or more cookies, or any combination thereof.

Clause 22. The non-transitory computer-readable medium of any of clauses 17 to 21, wherein the selectively scanning scans the first web page via one or more web page plugins if the degree of similarity between the first deduplicated web page data and the second deduplicated web page data exceeds a similarity threshold.

Clause 23. The non-transitory computer-readable medium of clause 22, wherein the similarity threshold is exceeded if the first deduplicated web page data includes at least one attack vector element that is not part of the second deduplicated web page data.

Clause 24. The non-transitory computer-readable medium of any of clauses 22 to 23, wherein, if the degree of similarity between the first deduplicated web page data and the second deduplicated web page data does not exceed the similarity threshold, the selectively scanning comprises: scan a server associated with the first web page via one or more server plugins of the security scan function, scan a uniform resource locator (URL) associated with the first web page via one or more URL plugins of the security scan function, and skip a scanning of the first web page via the one or more web page plugins of the security scan function.

Clause 25. An apparatus comprising a memory, a transceiver, and a processor communicatively coupled to the memory and the transceiver, the memory, the transceiver, and the processor configured to perform a method according to any of clauses 1 to 24.

Clause 26. An apparatus comprising means for performing a method according to any of clauses 1 to 24.

Clause 27. A non-transitory computer-readable medium storing computer-executable instructions, the computer-executable comprising at least one instruction for causing a computer or processor to perform a method according to any of clauses 1 to 24.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

1. A method of operating a web application scanner component, comprising:
retrieving a set of first web page vector elements associated with a first web page;
producing a set of first deduplicated web page vector elements associated with the set of first web page vector elements by performing (i) a first deduplication function on the set of first web page vector elements to remove one or more non-auditable vector elements from the set of first web page vector elements, and (ii) a second deduplication function on the set of first web page vector elements to remove one or more attack vector elements from the set of first web page vector elements that are already queued for scanning via a security scan function or have already been scanned via the security scan function; and
selectively scanning the first web page via the security scan function based on a degree of similarity between the set of first deduplicated web page vector elements and a set of second deduplicated web page vector elements that is deduplicated from a set of second web page vector elements associated with a second web page.

2. The method of claim 1, wherein the set of second web page vector elements is queued for scanning via the security scan function or has already been scanned via the security scan function.

3. The method of claim 1, wherein the set of first deduplicated web page vector elements comprises a hash of a portion of the set of first web page vector elements that excludes the one or more non-auditable vector elements and the one or more attack vector elements.

4. The method of claim 1, wherein the one or more non-auditable vector elements that are removed from the set of first web page vector elements via the first deduplication function include:
web page transition content, or
text content, or
image content, or
video content, or
audio content, or
style or formatting content, or
any combination thereof.

5. The method of claim 1, wherein the one or more attack vector elements comprise:
one or more forms, or
one or more cookies, or
any combination thereof.

6. The method of claim 1, wherein the selectively scanning scans the first web page via one or more web page plugins if the degree of similarity between the set of first deduplicated web page vector elements and the set of second deduplicated web page vector elements exceeds a similarity threshold.

7. The method of claim 6, wherein the similarity threshold is exceeded if the set of first deduplicated web page vector elements includes at least one attack vector element that is not part of the set of second deduplicated web page vector elements.

8. The method of claim 6, wherein, if the degree of similarity between the set of first deduplicated web page vector elements and the set of second deduplicated web page vector elements does not exceed the similarity threshold, the selectively scanning comprises:
scanning a server associated with the first web page via one or more server plugins of the security scan function,
scanning a uniform resource locator (URL) associated with the first web page via one or more URL plugins of the security scan function, and
skipping a scanning of the first web page via the one or more web page plugins of the security scan function.

9. A web application scanner component, comprising:
a memory; and
at least one processor communicatively coupled to the memory, the at least one processor configured to:
retrieve a set of first web page vector elements associated with a first web page;
produce a set of first deduplicated web page vector elements associated with the set of first web page vector elements by performing (i) a first deduplication function on the set of first web page vector elements to remove one or more non-auditable vector elements from the set of first web page vector elements, and (ii) a second deduplication function on the set of first web page vector elements to remove one or more attack vector elements from the set of first web page vector elements that are already queued for scanning via a security scan function or have already been scanned via the security scan function; and
selectively scan the first web page via the security scan function based on a degree of similarity between the set of first deduplicated web page vector elements and a set of second deduplicated web page vector elements that is deduplicated from a set of second web page vector elements associated with a second web page.

10. The web application scanner component of claim 9, wherein the set of second web page vector elements is queued for scanning via the security scan function or has already been scanned via the security scan function.

11. The web application scanner component of claim 9, wherein the set of first deduplicated web page vector elements comprises a hash of a portion of the set of first web page vector elements that excludes the one or more non-auditable vector elements and the one or more attack vector elements.

12. The web application scanner component of claim 9, wherein the one or more non-auditable vector elements that are removed from the set of first web page vector elements via the first deduplication function include:
web page transition content, or
text content, or
image content, or
video content, or
audio content, or
style or formatting content, or
any combination thereof.

13. The web application scanner component of claim 9, wherein the one or more attack vector elements comprise:
one or more forms, or
one or more cookies, or
any combination thereof.

14. The web application scanner component of claim 9, wherein the selectively scanning scans the first web page via one or more web page plugins if the degree of similarity between the set of first deduplicated web page vector elements and the set of second deduplicated web page vector elements exceeds a similarity threshold.

15. The web application scanner component of claim 14, wherein the similarity threshold is exceeded if the set of first deduplicated web page vector elements includes at least one attack vector element that is not part of the set of second deduplicated web page vector elements.

16. The web application scanner component of claim 14, wherein, if the degree of similarity between the set of first deduplicated web page vector elements and the set of second deduplicated web page vector elements does not exceed the similarity threshold, the selectively scanning comprises:
scan a server associated with the first web page via one or more server plugins of the security scan function,
scan a uniform resource locator (URL) associated with the first web page via one or more URL plugins of the security scan function, and
skip a scanning of the first web page via the one or more web page plugins of the security scan function.

17. A non-transitory computer-readable medium storing computer-executable instructions that, when executed by a web application scanner component, cause the web application scanner component to:
retrieve a set of first web page vector elements associated with a first web page;
produce a set of first deduplicated web page vector elements associated with the set of first web page vector elements by performing (i) a first deduplication function on the set of first web page vector elements to remove one or more non-auditable vector elements from the set of first web page vector elements, and (ii) a second deduplication function on the set of first web page vector elements to remove one or more attack vector elements from the set of first web page vector elements that are already queued for scanning via a security scan function or have already been scanned via the security scan function; and
selectively scan the first web page via the security scan function based on a degree of similarity between the set of first deduplicated web page vector elements and a set of second deduplicated web page vector elements that is deduplicated from a set of second web page vector elements associated with a second web page.

18. The non-transitory computer-readable medium of claim 17, wherein the set of second web page vector elements is queued for scanning via the security scan function or has already been scanned via the security scan function.

19. The non-transitory computer-readable medium of claim 17, wherein the set of first deduplicated web page vector elements comprises a hash of a portion of the set of first web page vector elements that excludes the one or more non-auditable vector elements and the one or more attack vector elements.

20. The non-transitory computer-readable medium of claim 17, wherein the one or more non-auditable vector elements that are removed from the set of first web page vector elements via the first deduplication function include:
web page transition content, or
text content, or
image content, or
video content, or
audio content, or
style or formatting content, or
any combination thereof.

21. The non-transitory computer-readable medium of claim 17, wherein the one or more attack vector elements comprise:
one or more forms, or
one or more cookies, or
any combination thereof.

22. The non-transitory computer-readable medium of claim 17, wherein the selectively scanning scans the first web page via one or more web page plugins if the degree of similarity between the set of first deduplicated web page vector elements and the set of second deduplicated web page vector elements exceeds a similarity threshold.

23. The non-transitory computer-readable medium of claim 22, wherein the similarity threshold is exceeded if the set of first deduplicated web page vector elements includes at least one attack vector element that is not part of the set of second deduplicated web page vector elements.

24. The non-transitory computer-readable medium of claim 22, wherein, if the degree of similarity between the set of first deduplicated web page vector elements and the set of second deduplicated web page vector elements does not exceed the similarity threshold, the selectively scanning comprises:
scan a server associated with the first web page via one or more server plugins of the security scan function,
scan a uniform resource locator (URL) associated with the first web page via one or more URL plugins of the security scan function, and
skip a scanning of the first web page via the one or more web page plugins of the security scan function.
